(19) United States
(12) Patent Application Publication
(10) Pub. No.: US 2026/0260281 A1
(43) Pub. Date: Sep. 3, 2026

(54) INFORMATION PROCESSING DEVICE

(71) Applicant: NTT DOCOMO, INC., Tokyo (JP)

(72) Inventors: Sho MAEOKI, Tokyo (JP); Yuri SASAKI, Tokyo (JP); Wataru AKASHI, Tokyo (JP)

(73) Assignee: NTT DOCOMO, INC., Tokyo (JP)

(21) Appl. No.: 19/162,186

(22) PCT Filed: Feb. 20, 2024
(86) PCT No.: PCT/JP2024/006103

§ 371 Date: Sep. 4, 2025

(30) Foreign Application Priority Data
May 26, 2023 (JP) 2023-086737

(51) Int. Cl. G06Q 30/0601; G06N 20/00

(52) U.S. Cl. CPC G06Q 30/06314; G06N 20/00

(57) ABSTRACT

An information processing device (10) includes a style selection unit (11) that selects style information of a user based on user information including at least one of attribute information and behavior information of the user; a description generation unit (12) that generates a recommendation description based on a predetermined recommendation basis regarding recommended content and the style information selected by the style selection unit (11); and a presentation unit (13) that presents the recommendation description to the user generated by the description generation unit (12).

### TECHNICAL FIELD

The present disclosure relates to an information processing device that presents a user with a recommendation reason description along with recommended content. Here, “content” broadly includes various products (e.g., video works, books, etc.) and various services (e.g., provision of video works, sale of books, etc.).

### BACKGROUND ART

Recommendation systems that present recommended content to users are conventionally known. In such recommendation systems, generally, the reason for the recommendation is not presented to the user. Therefore, a technology has been proposed that presents the user with a recommendation reason description based on metadata of the recommended content along with the content itself (see Patent Literature 1).

### CITATION LIST

### Patent Literature

[Patent Literature 1] Japanese Unexamined Patent Publication No. 2006-309751

### SUMMARY OF INVENTION

### Problems to be Solved by the Invention

However, the generation and presentation to the user of a recommendation reason description that is more personalized and highly appealing to individual users, and further based on the style information of the user (e.g., attribute information specific to the user, behavior information according to the user's preferences, etc.), have not been considered.

Therefore, the present disclosure aims to generate a recommendation reason description that is more personalized and highly appealing to individual users and present the recommendation reason description to the user.

### Solution to Problem

The information processing device according to the present disclosure includes: a style selection unit that selects style information of a user based on user information including at least one of attribute information and behavior information of the user; a description generation unit that generates a recommendation description based on a predetermined recommendation basis related to recommended content and the style information of the user selected by the style selection unit; and a presentation unit that presents the recommendation description generated by the description generation unit to the user.

In the above information processing device, the style selection unit selects the style information of the user based on user information including at least one of attribute information and behavior information of the user, the description generation unit generates a recommendation description based on the predetermined recommendation reason related to the recommended content and the selected style information of the user, and the presentation unit presents the generated recommendation description to the user. Thus, the recommendation description is generated and presented to the user not only based on the recommendation basis related to the recommended content but also further based on the style information selected based on the user information. In this way, it is possible to generate a recommendation reason description that is more personalized and highly appealing to individual users and present the recommendation reason description to the user.

### Advantageous Effects of Invention

According to the present disclosure, it is possible to generate a recommendation reason description that is more personalized and highly appealing to individual users and present the recommendation reason description to the user.

### BRIEF DESCRIPTION OF DRAWINGS

FIG. 1 is a functional block configuration diagram of the information processing device.

FIG. 2 is a diagram explaining data used for learning by a description generation unit.

FIG. 3 is a diagram explaining the learning of the description generation unit.

FIG. 4 is a diagram explaining data used for learning by a style selection unit.

FIG. 5 is a diagram explaining the learning of the style selection unit.

FIG. 6 is a diagram explaining the learning of the style selection unit.

FIG. 7 is a flowchart showing a process executed by the information processing device after learning is completed.

FIG. 8(a) is a diagram showing an example of presenting a recommendation reason description, and FIG. 8(b) a diagram showing another example of presenting a recommendation reason description.

FIG. 9 is a diagram showing an example of a hardware configuration of the information processing device.

### DESCRIPTION OF EMBODIMENTS

Hereinafter, embodiments of the present disclosure will be described with reference to the drawings. In the following embodiments, it is assumed that the content to be recommended to the target user has already been selected by a known technology, and the recommendation basis has been predetermined using a known explainable AI (XAI) technology.

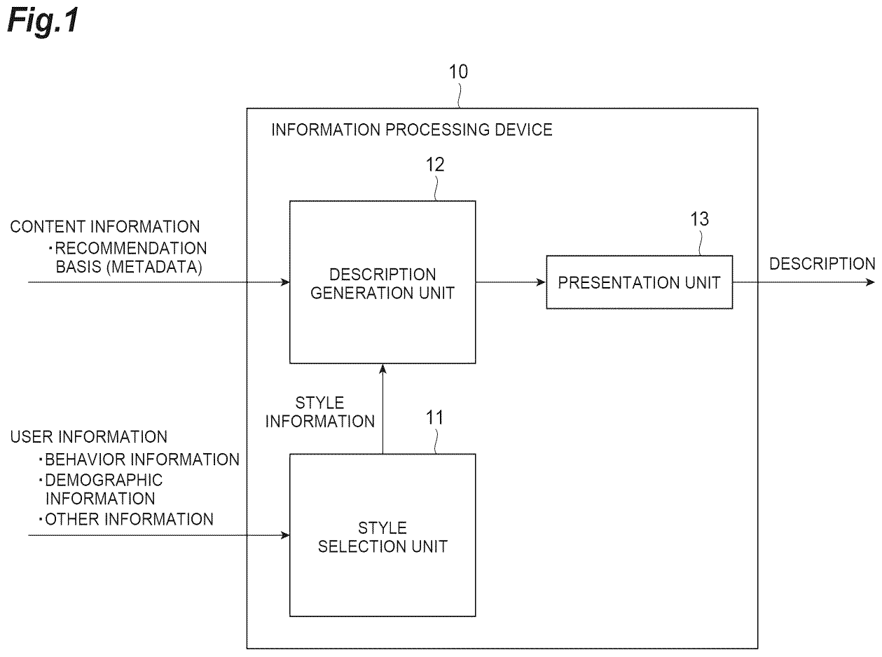

As shown in FIG. 1, the information processing device 10 in the embodiment includes, as functional blocks for realizing the functions of the present disclosure, a style selection unit 11 that selects style information of the user based on user information including at least one of attribute information and behavior information of the user, a description generation unit 12 that generates a recommendation description based on a predetermined recommendation basis related to the recommended content and the style information of the user selected by the style selection unit 11, and a presentation unit 13 that presents the generated recommendation description to the user.

As described in detail below, the style selection unit 11 learns, using a reinforcement learning approach, a probability function regarding which style information should be selected for which user based on user information and behavioral results of the user (e.g., click logs, etc.) related to content corresponding to recommendation descriptions linked to previously selected style information, and selects the style information of the user using the probability function obtained through learning. In other words, the style selection unit 11 learns, using a reinforcement learning approach, a probability function to select style information that maximizes the reward related to the user's response to the content when user information is input, and selects the style information of the user using the probability function obtained through learning.

Additionally, the description generation unit 12 performs learning with style information and the recommendation description generated based on the recommendation basis (a recommendation description reflecting the recommendation basis) as the explanatory variables and the recommendation description which takes into account the style information as the target variable, and generates a recommendation description based on the learning results obtained through learning.

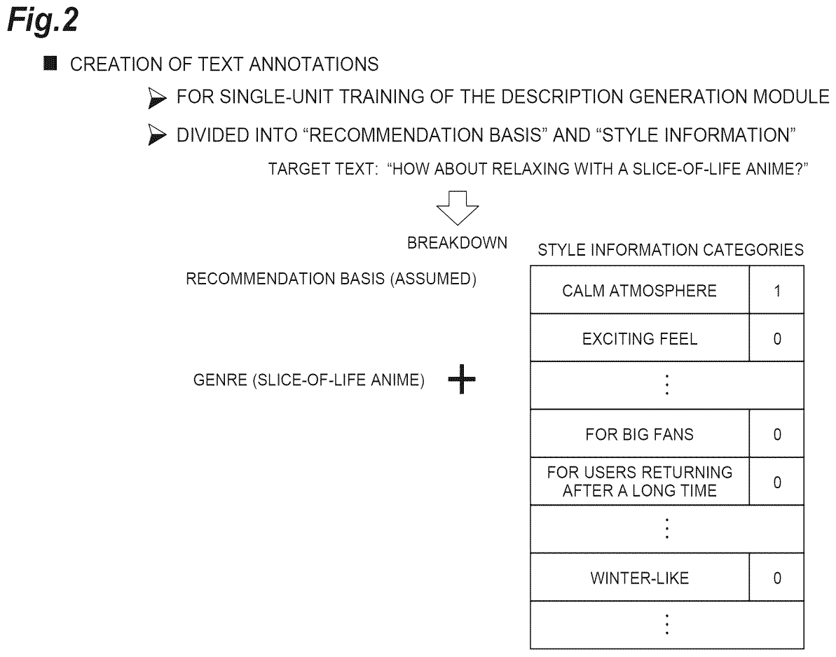

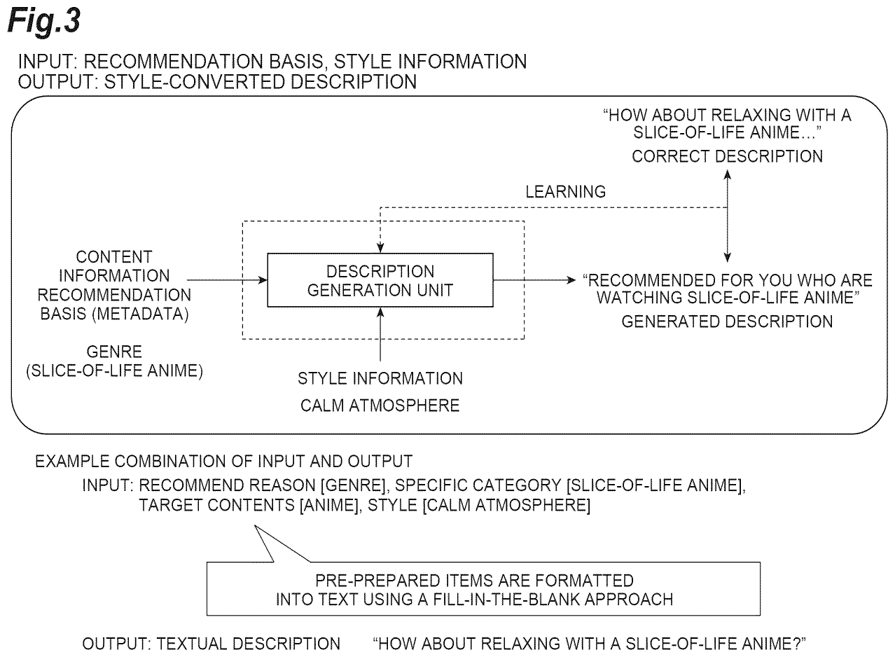

Here, the learning of the description generation unit 12 will be described with reference to FIGS. 2 and 3. As shown in FIG. 2, to acquire learning data for individual training of the description generation unit 12, the description generation unit 12 collects correspondences between product groups and catchphrases in the world to create text annotations. Specifically, the target text is divided into “inference reason” and “style information.” For example, the target text “How about relaxing with a slice-of-life anime?” is divided into “inference reason (assumed)=genre (slice-of-life anime)” and “flag ‘1’ corresponding to ‘calm atmosphere’ in the style information category.”

Then, as shown in FIG. 3, the description generation unit 12 performs learning with the style information and the recommendation description generated based on the recommendation basis (a recommendation description reflecting the recommendation basis) as the explanatory variable, and the recommendation description which takes into account the style information as the target variable. In the example of FIG. 3, learning is performed with the style information of “calm atmosphere” and the recommendation basis of “genre (slice-of-life anime)” as explanatory variables, and with the recommendation description (i.e., “How about relaxing with a slice-of-life anime?”), which takes into account the style information, as the target variable. As a learning method for generating descriptions using style information as a condition, methods such as Prefix Tuning (see https://arxiv.org/abs/2101.00190), which is known to be capable of achieving high-performance learning even with small datasets, may also be used.

The description generation unit 12 generates a recommendation description based on the learning results obtained as described above.

By generating recommendation descriptions based on such learning results, it is possible to contribute to generating recommendation reason descriptions that are more personalized and highly appealing to individual users.

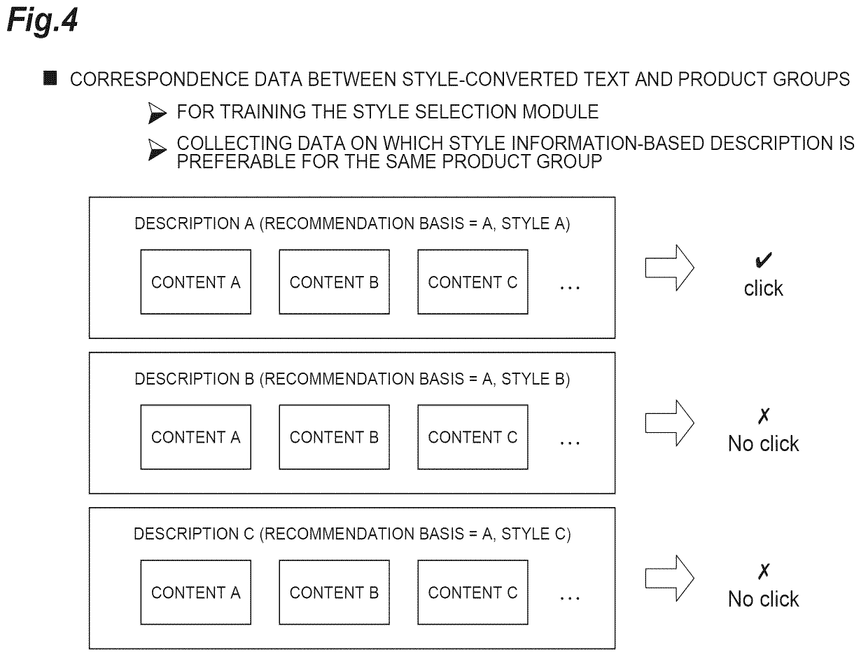

Next, the learning of the style selection unit 11 will be described with reference to FIGS. 4 to 6. As shown in FIG. 4, the style selection unit 11 collects, for learning purposes, “style-converted text and product group correspondence data,” i.e., data on which style information-based description is preferable for the same product group. In the example of FIG. 4, when an explanation A generated based on a recommendation basis (recommendation basis A) and style A was presented to the user, it was clicked by the user. However, when descriptions B and C, generated based on the same recommendation basis (recommendation basis A) and styles B and C, respectively, were presented to the same user, they were not clicked by the user. Such data is collected.

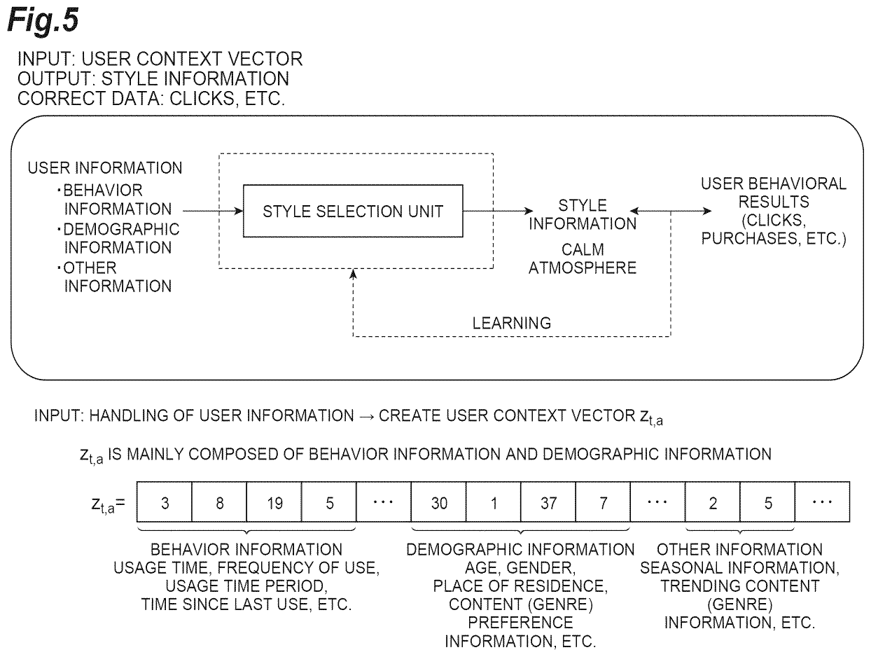

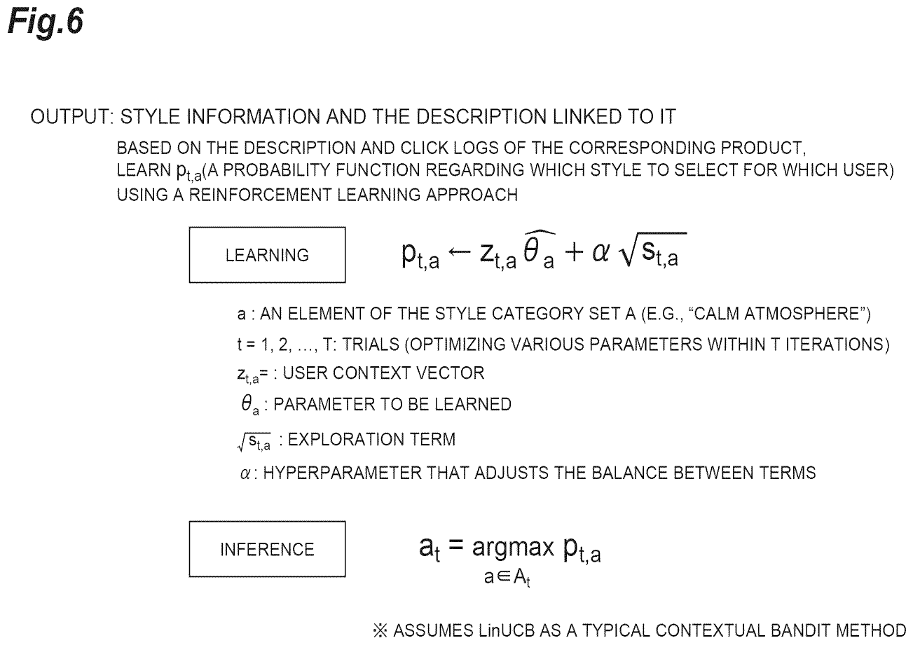

Next, the style information selection by the style selection unit 11 will be described with reference to FIGS. 5 and 6. As described above, the style selection unit 11 learns, using a reinforcement learning approach, a probability function regarding which style to select for which user to maximize the reward related to the user's response to the content when user information is input, and selects the style information of the user using the probability function obtained through learning. In the learning phase described above, for example, the style selection unit 11 creates a user context vector (Equation 1) from the input user information.

$${z}_{t , a} \qquad [ Equation 1 ]$$

As shown in FIG. 5, the user context vector (Equation 2) is mainly composed of “behavior information” and “demographic information.”

$${z}_{t , a} \qquad [ Equation 2 ]$$

Among these, behavior information includes information such as usage time, number of uses, usage time period, and time since last use, while demographic information includes information such as age, gender, place of residence, and content (genre) preference information. Additionally, other information (information related to external factors) such as seasonal information and popular content (genre) information can also be included. This information serves as reference information for style selection by the style selection unit 11.

In the learning phase, as shown in FIG. 6, the style selection unit 11 learns, using a reinforcement learning approach, a probability function (Equation 3) regarding which style to select for which user based on the description and the click logs of the corresponding product.

$${p}_{t , a} \qquad [ Equation 3 ]$$

This learning can be expressed by the following formula:

$$\begin{matrix}[ Equation 4 ] & \\ {p}_{t , a} ← {z}_{t , a} \text{?} + α \sqrt{{s}_{t , a}} & ( 1 )\end{matrix}$$

a: An element of the style category set A (e.g., “calm atmosphere”)
t=1, 2, . . . , T: Trial (optimizing various parameters within T iterations)
z_{t,a}: User context vector
θₐ: Parameter to be learned
√s_{t,a}: Exploration term
α: A hyperparameter that adjusts the balance between terms

In the inference phase after learning is completed, the style selection unit 11 selects user's style information using the probability function (Equation 5) obtained through learning.

$${p}_{t , a} \qquad [ Equation 5 ]$$

For example, assuming the Linear Upper Confidence Bounds (LinUCB) as a typical contextual bandit method, the style information is selected using the following formula (2):

$$\begin{matrix}[ Equation 6 ] & \\ {a}_{t} = {arg max {p}_{t , q}}_{a ∈ {𝒜}_{t}} & ( 2 )\end{matrix}$$

By selecting the style information of the user using the probability function obtained through such a reinforcement learning-based approach, it is possible to contribute to generating recommendation reason descriptions that are more personalized and highly appealing to individual users.

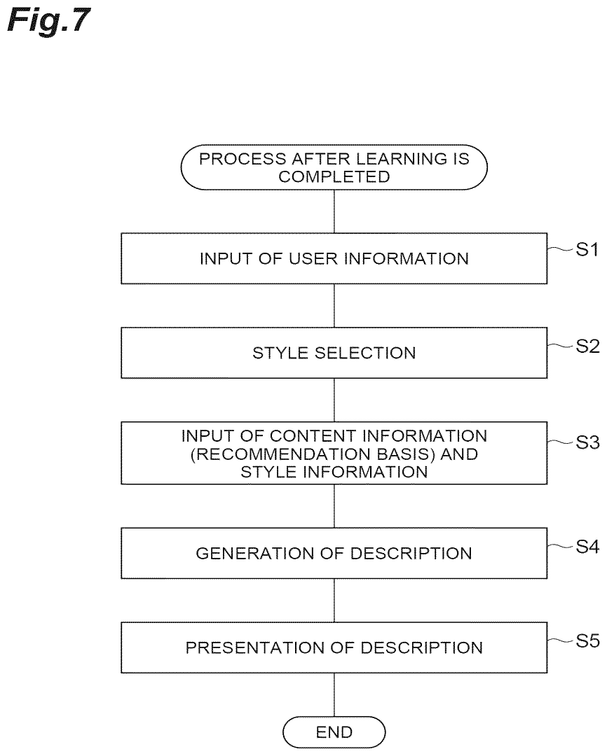

Next, the process after completion of learning will be described along with the flowchart in FIG. 7. First, the style selection unit 11 receives user information (including behavior information, demographic information, and other information) input from an external source (Step S1) and selects the style information of the user by using the probability function (Equation 7) obtained through learning in accordance with the above formula (2) (Step S2).

$${p}_{t , a} \qquad [ Equation 7 ]$$

Then, the description generation unit 12 receives content information (the recommendation basis for the content) input from an external source and the style information selected by the style selection unit 11 (Step S3) and generates a recommendation description based on the learning results obtained through learning (Step S4). Furthermore, the presentation unit 13 presents the description generated by the description generation unit 12 to the user (Step S5).

Through the embodiment described above, a recommendation description is generated and presented to the user not only based on the recommendation basis related to the recommended content but also further based on the style information selected according to the user information. In this way, it is possible to generate a recommendation reason description that is more personalized and highly appealing to individual users and present the recommendation reason description to the user.

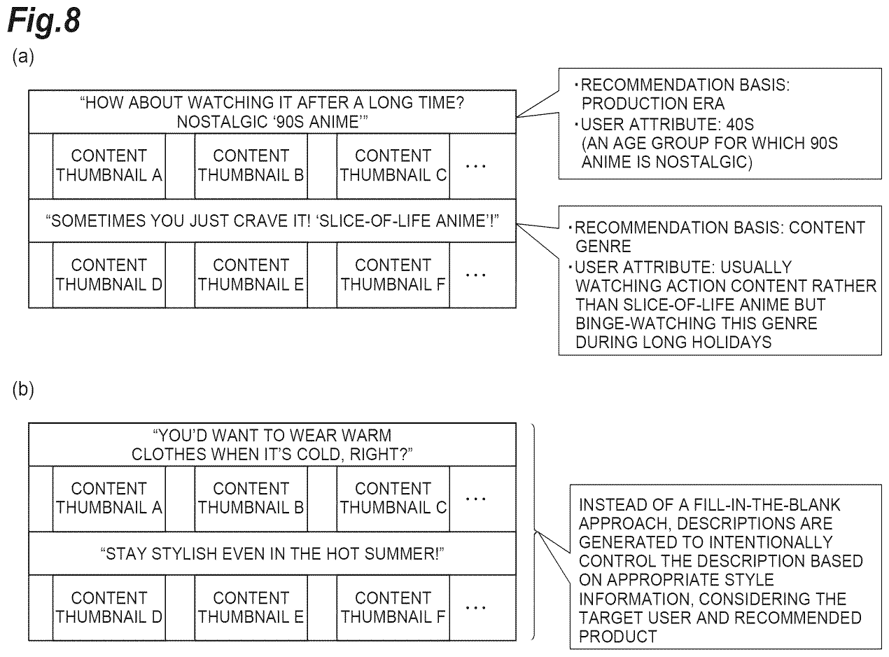

As specific examples, FIGS. 8(a) and 8(b) show examples of descriptions presented to the user. The upper part of FIG. 8(a) lists the description “How about watching it after a long time? Nostalgic ‘90s anime’,” which is generated based on the recommendation basis of “production era” and which takes into account the user attribute of people in their 40s, an age group for which 90s anime is nostalgic. The lower part of FIG. 8(a) lists the description “Sometimes you just crave it!” ‘Slice-of-life anime’!.” This description is generated based on the recommendation basis of “work genre,” taking into account the user attribute of “usually not watching slice-of-life anime, typically watching action-oriented content, and intensively watching this genre during periods such as long holidays.” Additionally, FIG. 8(b) illustrates examples of descriptions that are intentionally controlled through language generation—not fill-in-the-blank insertion—based on the target user and the recommended content (product), using appropriate style information. Examples include descriptions such as “You′d want to wear warm clothes when it's cold, right?” and “Stay stylish even in the hot summer!”

Furthermore, examples of descriptions generated by reflecting style information are listed below:
(1) For the recommendation basis of genre “battle anime” and style information reflecting “for users who have returned to the service after a long time,” the following description is generated: “Experience the excitement once again with ‘battle anime’! This work is perfect for those resuming use of the service.”
(2) For the recommendation basis of cast “voice actor A” and style information reflecting “for big fans,” the following description is generated: “All of these works are packed with charm and are sure to satisfy even those who are big fans of ‘voice actor A’.”
(3) For the recommendation basis of viewed content “Work B” and style information reflecting “winter-like,” the following description is generated: “On cold winter days, a heartwarming story is just right. This is a story we wish to deliver to those who have watched ‘Work B’.”
(4) For the recommendation basis of genre “wizard” and style information reflecting “exciting feel,” the following description is generated: “Anime featuring wizards is the standard of fantasy. What if you could use magic [symbol] ”
(5) For the recommendation basis of genre “mystery” and style information reflecting “serious feel,” the following description is generated: “Immerse yourself in an intricately woven story. These authentic works, brimming with a remarkable sense of tension, are presented for fans of mystery like you.”

The style information such as “exciting feel” and “serious feel” as mentioned in (4) and (5) above can be obtained by using behavior information, such as the types of content (e.g., video works, books) that the user usually consumes and which reflect user preferences, as foundational data for style selection. As is evident from the various examples above, in this embodiment, it is possible to generate and present to each user a recommendation reason description that is more personalized and highly appealing to the individual user.

This disclosure includes the following points [1] to [4]:
[1] An information processing device comprising:
a style selection unit that selects style information of a user based on user information including at least one of attribute information and behavior information of the user;
a description generation unit that generates a recommendation description based on a predetermined recommendation basis for recommended content and the style information of the user selected by the style selection unit; and
a presentation unit that presents the recommendation description generated by the description generation unit to the user.
[2] The information processing device according to [1], wherein the description generation unit performs learning with the style information and the recommendation description generated based on the recommendation basis, reflecting the recommendation basis, as an explanatory variable, and a recommendation description that takes into account the style information as a target variable, and generates the recommendation description based on learning results obtained through the learning.
[3] The information processing device according to [1],
wherein the style selection unit learns, using a reinforcement learning approach, a probability function as to which style information should be selected for which user based on the user information and behavioral results of the user related to content corresponding to recommendation descriptions linked to previously selected style information, and selects the style information of the user using the probability function obtained through the learning.
[4] The information processing device according to [3],
wherein the style selection unit learns, using a reinforcement learning approach, the probability function for selecting style information that maximizes a reward related to the user's response to the content when the user information is input, and selects the style information of the user using the probability function obtained through the learning.

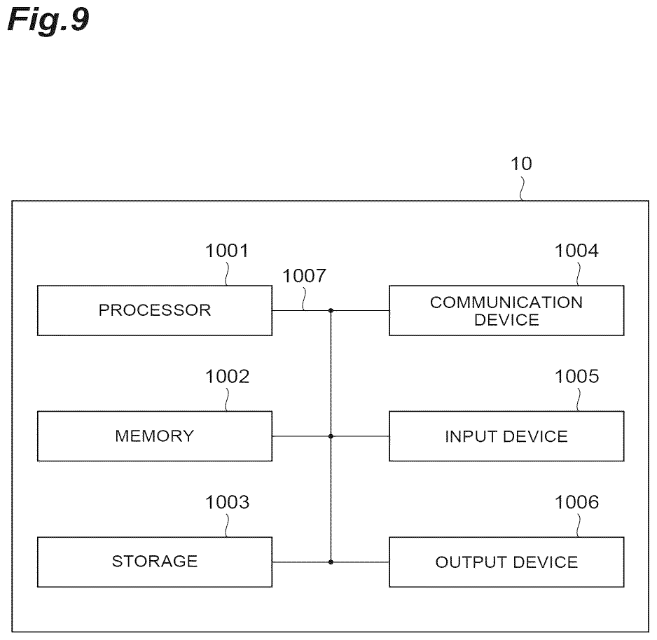

### (Explanation of Terms, Description of Hardware Configuration (FIG. 9), Etc.)

In the block diagrams with reference to which the embodiment has been described, blocks of functional units are illustrated. Such functional blocks (component units) are realized by an arbitrary combination of at least one of hardware and software. In addition, a method for realizing each functional block is not particularly limited. In other words, each functional block may be realized by using one device that is combined physically or logically or using a plurality of devices by directly or indirectly (for example, using a wire or wirelessly) connecting two or more devices separated physically or logically. A functional block may be realized by one device or a plurality of devices described above and software in combination.

The functions include determining, deciding, determination, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating or mapping, and assigning, but are not limited thereto. For example, a functional block (component) that causes transmission to function is called a transmitting unit or transmitter. In either case, as described above, implementation methods are not particularly limited.

For example, the information processing device according to an embodiment of the present disclosure may function as a computer that performs processing of the present disclosure. FIG. 9 is a diagram illustrating an example of a hardware configuration of the information processing device 10 according to the embodiment of the present disclosure. The above-described information processing device 10 may be physically configured as a computer device including a processor 1001, a memory 1002, a storage 1003, a communication device 1004, an input device 1005, an output device 1006, a bus 1007, and the like.

In addition, in the following description, the term “device” may be rephrased as a circuit, a device, a unit, or the like. The hardware configuration of the information processing device 10 may be configured to include one or more of respective devices shown in FIG. 9, or may be configured not to include some of the devices.

Each function in the information processing device 10 is realized by loading predetermined software (a program) into hardware such as the processor 1001 and the memory 1002 so that the processor 1001 performs calculation to control communication that is performed by the communication device 1004 and/or control at least one of reading and writing of data in the memory 1002 and the storage 1003.

The processor 1001, for example, controls the entire computer by executing an operating system. The processor 1001 may be configured as a central processing unit (CPU) including an interface with peripherals, a controller, an arithmetic operation unit, and a register.

The processor 1001 reads a program (a program code), a software module, data, or the like from the storage 1003 and/or the communication device 1004 into the memory 1002 and performs various processes in accordance therewith. As the program, a program that causes a computer to perform at least some of the operations described above in the embodiment is used. The various processes described above are described as being performed by a single processor 1001, but they may be simultaneously or sequentially performed by two or more processors 1001. The processor 1001 may be implemented as one or more chips. The program may be transmitted from a network via an telecommunication line.

The memory 1002 is a computer-readable recording medium and may be constituted by, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (main storage device), or the like. The memory 1002 can store an executable program (program code), a software module, or the like that can be executed to perform a wireless communication method according to an embodiment of the present disclosure.

The storage 1003 is a computer-readable recording medium and may be configured by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage medium described above, for example, may be a database including at least one of the memory 1002 and the storage 1003, a server, or any other appropriate medium.

The communication device 1004 is hardware (a transmitting and receiving device) that performs communication between computers via a wired or wireless network and is also referred to as, for example, a network device, a network controller, a network card, or a communication module. The communication device 1004, for example, in order to realize at least one of frequency division duplex (FDD) and time division duplex (TDD), may be configured to include a high frequency switch, a duplexer, a filter, a frequency synthesizer, and the like.

The input device 1005 is an input device (for example, a keyboard, a mouse, a microphone, a switch, a button, a sensor, or the like) that accepts an input from the outside. The output device 1006 is an output device (for example, a display, a speaker, an LED lamp, or the like) that performs output to the outside. In addition, the input device 1005 and the output device 1006 may have an integrated configuration (for example, a touch panel).

The devices such as the processor 1001 and the memory 1002 are connected to each other via the bus 1007 for communication of information. The bus 1007 may be configured using a single bus, or may be configured using different buses for each device.

In addition, the information processing device 10 may be configured to include hardware such as a microprocessor, a digital signal processor (DSP), an application specific integrated circuit (ASIC), a programmable logic device (PLD), a field programmable gate array (FPGA), or the like, and a part or the whole of each functional block may be realized by the hardware. For example, the processor 1001 may be implemented using at least one of these types of hardware.

Notification of information is not limited to an aspect/embodiment described in the present disclosure and may be performed using a different method. For example, the notification of information may be performed using physical layer signaling (for example, downlink control information (DCI), uplink control information (UCI)), upper layer signaling (for example, radio resource control (RRC) signaling, medium access control (MAC) signaling, a master information block (MIB), a system information block (SIB)), any other signal, or a combination thereof. In addition, the RRC signaling may be referred to as an RRC message and, for example, may be an RRC connection setup message, an RRC connection reconfiguration message, or the like.

Each aspect or embodiment described in the present disclosure may be applied to at least one of the following systems: Long Term Evolution (LTE), LTE-Advanced (LTE-A), SUPER 3G, IMT-Advanced, Fourth Generation Mobile Communication System (4G), Fifth Generation Mobile Communication System (5G), Sixth Generation Mobile Communication System (6G), xth Generation Mobile Communication System (xG, where x is, for example, an integer or a decimal), Future Radio Access (FRA), New Radio (NR), New Radio Access (NX), Future Generation Radio Access (FX), Wideband Code Division Multiple Access (W-CDMA, registered trademark), Global System for Mobile Communications (GSM, registered trademark), CDMA2000, Ultra Mobile Broadband (UMB), IEEE 802.11 (Wi-Fi, registered trademark), IEEE 802.16 (WiMAX, registered trademark), IEEE 802.20, Ultra-WideBand (UWB), Bluetooth (registered trademark), systems that use other suitable systems, and at least one next-generation system that has been extended, modified, created, or defined based on any of the above systems. In addition, a plurality of systems may be combined (for example, a combination of at least one of LTE and LTE-A and 5G or the like) for an application.

The order of processes, the sequences, the flowcharts, and the like of the aspects/embodiments described above in the present disclosure may be changed unless conflicts arise. For example, in the methods described in the present disclosure, various steps are described as elements of an exemplified order, but the methods are not limited to the described order.

Information or the like which is input or output may be stored in a specific place (for example, a memory) or may be managed using a management table. Information or the like which is input or output may be overwritten, updated, or appended. The output information and the like may be deleted. The input information and the like may be transmitted to another device.

Determination may be performed using a value (0 or 1) which is expressed by one bit, may be performed using a Boolean value (true or false), or may be performed by comparison of numerical values (for example, comparison thereof with a predetermined value).

The aspects/embodiments described in this disclosure may be used alone, may be used in combination, or may be alternated during implementation thereof. In addition, a notification of predetermined information (for example, a notification of being X) is not limited to be performed explicitly and may be performed implicitly (for example, a notification of the predetermined information is not performed).

As above, while the present disclosure has been described in detail, it is apparent to a person skilled in the art that the present disclosure is not limited to the embodiments described in the present disclosure. The present disclosure may be modified or altered without departing from the spirit and scope of the present disclosure as defined by the claims. Thus, the description presented in the present disclosure is for the purpose of exemplary description and does not have any limiting meaning for the present disclosure.

It is apparent that software, regardless whether it is called software, firmware, middleware, a microcode, a hardware description language, or any other name, should be widely interpreted to mean a command, a command set, a code, a code segment, a program code, a program, a subprogram, a software module, an application, a software application, a software package, a routine, a subroutine, an object, an executable file, an execution thread, a procedure, a function, and the like.

In addition, software, a command, information, and the like may be transmitted and received through a transmission medium. For example, when software is transmitted from a website, a server, or another remote source using at least one of wired technology (such as a coaxial cable, an optical fiber cable, a twisted-pair wire, or a digital subscriber line (DSL)) and wireless technology (such as infrared rays or microwaves), at least one of the wired technology and the wireless technology are included in the definition of a transmission medium.

Information, a signal, and the like described in the present disclosure may be represented using any of various different technologies. For example, data, an instruction, a command, information, a signal, a bit, a symbol, a chip, and the like described over the entire description presented above may be represented using a voltage, a current, radio waves, a magnetic field or magnetic particles, an optical field or photons, or an arbitrary combination thereof.

In addition, a term described in the present disclosure and a term that is necessary for understanding the present disclosure may be substituted with a term having the same meaning or a meaning similar thereto. For example, at least one of a channel and a symbol may be a signal (signaling). For example, a signal may be a message. In addition, a component carrier (CC) may be referred to as a carrier frequency, a cell, a frequency carrier, or the like.

The terms “system” and “network” used in the present disclosure are used interchangeably.

In addition, information, parameters, and the like described in the present disclosure may be expressed using absolute values, may be expressed using values relative to a predetermined value, or may be expressed using other corresponding information. For example, radio resources may be directed using indices.

A name used for each parameter described above is not limited in any aspect. In addition, numerical equations using such parameters may be different from those that are explicitly disclosed in the present disclosure. Various channels (for example, PUCCH, PDCCH, and the like) and information elements can be identified using any suitable names, and various names assigned to such various channels and information elements are not limited in any aspect.

Terms such as “determining” used in the present disclosure may include a variety of operations of various types. The “determining”, for example, may include a case in which judging, calculating, computing, processing, deriving, investigating, looking up, search, and inquiry (for example, looking up a table, a database, or any other data structure), or ascertaining is regarded as “determining.” In addition, “determining” may include a case in which receiving (for example, receiving information), transmitting (for example, transmitting information), input, output, or accessing (for example, accessing data in a memory) is regarded as “determining.” Furthermore, “determining” may include a case in which resolving, selecting, choosing, establishing, comparing, or the like is regarded as “determining.” In other words, “determining” includes a case in which a certain operation is regarded as “determining.” In addition, “determining” may be rephrased with “assuming”, “expecting”, “considering”, and the like.

The expression “based on” used in the present disclosure does not mean “based on only” unless otherwise described. In other words, the expression “on the basis of” means both “only on the basis of”′ and “at least on the basis of.”

Any reference to elements, for which names of “first”, “second”, and the like are used, used in the present disclosure does not generally limit the amount or the sequence of such elements. The terms can be conveniently used to distinguish two or more elements in the present disclosure. Accordingly, referring to the first and second elements does not mean that only the two elements are employed there or the first element precedes the second element in a certain form.

When the terms “include” and “including” and modifications thereof are used in the present disclosure, the terms are intended to have a comprehensive meaning similar to the term “comprising.” The term “or” used in the present disclosure is not intended to mean an exclusive OR.

In the present disclosure, for example, when an article such as a, an, or the in English is added in translation, the present disclosure may include a case in which a noun subsequent to the article is of a plural type.

In the present disclosure, a term “A and B are different” may mean that “A and B are respectively different from each other.” The expression may mean that “A and B are different from C.” Expressions such as “separate” and “couple” may be construed in the same way as “different.”

### REFERENCE SIGNS LIST

10 Information processing device, 11 Style selection unit, 12 Description generation unit, 13 Presentation unit, 1001 Processor, 1002 Memory, 1003 Storage, 1004 Communication device, 1005 Input device, 1006 Output device, 1007 Bus

1. An information processing device comprising:
a style selection unit that selects style information of a user based on user information including at least one of attribute information and behavior information of the user;
a description generation unit that generates a recommendation description based on a predetermined recommendation basis for recommended content and the style information of the user selected by the style selection unit; and
a presentation unit that presents the recommendation description generated by the description generation unit to the user.

2. The information processing device according to claim 1,
wherein the description generation unit performs learning with the style information and the recommendation description generated based on the recommendation basis, reflecting the recommendation basis, as an explanatory variable, and a recommendation description that takes into account the style information as a target variable, and generates the recommendation description based on learning results obtained through the learning.

3. The information processing device according to claim 1,
wherein the style selection unit learns, using a reinforcement learning approach, a probability function as to which style information should be selected for which user based on the user information and behavioral results of the user related to content corresponding to recommendation descriptions linked to previously selected style information, and selects the style information of the user using the probability function obtained through the learning.

4. The information processing device according to claim 3,
wherein the style selection unit learns, using a reinforcement learning approach, the probability function for selecting style information that maximizes a reward related to the user's response to the content when the user information is input, and selects the style information of the user using the probability function obtained through the learning.
